(19) United States
(12) Patent Application Publication
(10) Pub. No.: US 2026/0002573 A1
(43) Pub. Date: Jan. 1, 2026

(54) ANTI-CAVITATION PISTON FOR SHOCK ABSORBER

(71) Applicant: Fox Factory, Inc., Duluth, GA (US)

(72) Inventors: Connor Randall, Poncha Springs, CO (US); Blake Nicholas, Elbert, CO (US); Samuel Buller, San Diego, CA (US)

(21) Appl. No.: 19/257,366

(22) Filed: Jul. 1, 2025

Related U.S. Application Data
(60) Provisional application No. 63/666,405, filed on Jul. 1, 2024.

(51) Int. Cl. F16F 9/32; F16F 9/18; F16F 9/348; F16F 9/50

(52) U.S. Cl. CPC F16F 9/3214; F16F 9/182; F16F 9/3221; F16F 9/348; F16F 9/50; F16F 2222/12; F16F 2228/04; F16F 2228/066; F16F 2230/0023; F16F 2230/18; F16F 2230/42

(57) ABSTRACT

An anti-cavitation piston for use with shock absorbers is provided. The anti-cavitation piston enables improved damping performance and pressure balance. An embodiment of the anti-cavitation piston includes a two part main piston having a first piston member coupled to a second piston member and additional ports and valving to control damping and reduce or inhibit cavitation during compression and rebound strokes of the shock absorber. Another embodiment of the anti-cavitation piston includes a twin piston device having a first piston and a second piston and additional boost valves, other valving and electronic valving and ports to control damping and reduce or inhibit cavitation during compression and rebound strokes of the shock absorber.

### CROSS REFERENCE TO RELATED APPLICATION[S]

This application claims priority to U.S. Provisional Patent Application 63/666,405, filed Jul. 1, 2024, the disclosure of which is hereby incorporated entirely herein by reference.

### BACKGROUND OF THE INVENTION

### Technical Field

This invention relates generally to shock absorbers for vehicles, and more particularly to an anti-cavitation piston for shock absorbers that enables improved damping performance and pressure balance.

### State of the Art

Shock absorbers are widely used in vehicles to provide a smoother ride by dampening oscillations and absorbing impact forces. These devices typically consist of a shock body filled with hydraulic fluid and a piston that moves through the fluid as the vehicle encounters bumps or uneven terrain. The movement of the piston through the fluid creates resistance, which dissipates energy and reduces unwanted motion.

In conventional shock absorber designs, a single main piston is often employed to control fluid flow and generate damping forces. However, this configuration can lead to challenges in maintaining proper pressure balance within the system. Pressure imbalances may result in cavitation, a phenomenon where vapor bubbles form and collapse in the hydraulic fluid due to rapid changes in pressure. Cavitation can degrade shock absorber performance and potentially cause damage to internal components over time.

To address pressure balance issues, some shock absorber designs incorporate secondary base valves or utilize high gas pressure. While these approaches can help mitigate cavitation risks, they may introduce additional complexity or affect other aspects of shock absorber performance.

Accordingly, there is a need for an improved piston for shock absorbers that reduces cavitation without the drawbacks presented by existing technology.

### SUMMARY OF THE INVENTION

An embodiment includes an anti-cavitation piston for use in a shock absorber, comprising: a main piston comprising: a first piston member; a second piston member coupled to the first piston member; a single wear band coupled around the first piston member and the second piston member, wherein the single wear band separates a compression side from a rebound side of the main piston; a first recessed portion in the first piston member; a second recessed portion in the second piston member, wherein the first recessed portion and the second recessed portion form a piston inner volume when the first piston member is coupled to the second piston member; a first compression port in the first piston member providing fluid flow access to the piston inner volume; a first rebound port in the second piston member providing fluid flow access to the piston inner volume; and compression valving and rebound valving operatively coupled within the piston inner volume between the first piston member and the second piston member.

Another embodiment includes an anti-cavitation piston for use in a shock absorber, comprising: a twin piston device comprising: a first piston and a second piston arranged in series and coupled to a shaft of the shock absorber; a first central chamber adjacent to the first piston; a second central chamber adjacent to the second piston; a first electronic valve operatively coupled to engage an opening to the first central chamber; a second electronic valve operatively coupled to engage an opening to the second central chamber; and a shaft displacement port configured to enable fluid flow through the twin piston device and through the shaft.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a sectional view of a shock absorber, according to an embodiment;

FIG. 2 is a sectional view of a shock absorber showing internal components, according to an embodiment;

FIG. 3 is a sectional view of the shock absorber of FIG. 2 in compression, according to an embodiment;

FIG. 4 is a sectional view of the shock absorber of FIG. 2 in rebound, according to an embodiment;

FIG. 5 is a section view of a piston assembly for a shock absorber, according to an embodiment;

FIG. 6 is a section view of a shock absorber with a twin piston device, according to an embodiment;

FIG. 7 is a sectional view of the shock absorber of FIG. 6 showing internal components, according to an embodiment;

FIG. 8 is a sectional view of the shock absorber of FIG. 6 during compression, according to an embodiment;

FIG. 9 is a sectional view of the shock absorber of FIG. 6 during rebound, according to an embodiment;

FIG. 10 is a perspective view of a portion of a shaft assembly, according to an embodiment; and

FIG. 11 is a sectional view of the twin piston device of FIG. 6 in a shock absorber with an internal bypass, according to an embodiment.

### DETAILED DESCRIPTION OF EMBODIMENTS OF THE INVENTION

As discussed above, embodiments of the present invention relate to an anti-cavitation piston for shock absorbers. The anti-cavitation piston embodiments operate to prevent or reduce cavitation effects, leading to more consistent and reliable damping performance across a range of operating conditions.

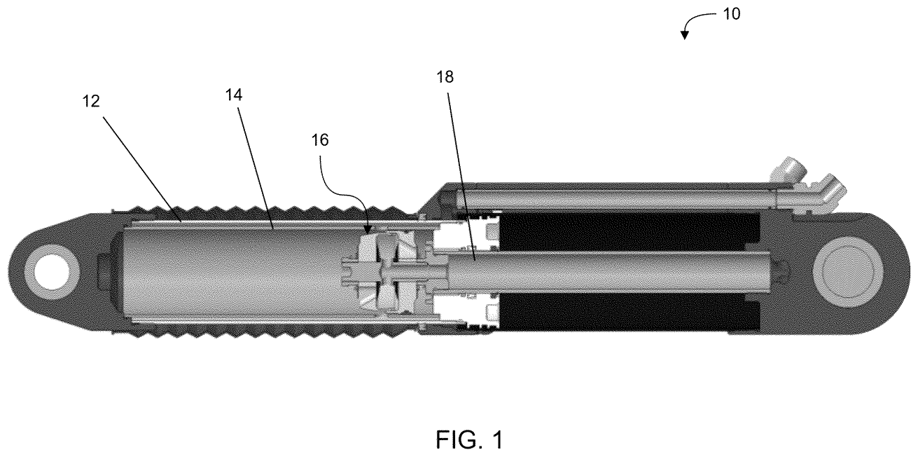

FIG. 1 depicts a sectional view of a shock absorber 10 according to an embodiment. The shock absorber 10 may include a shock outer body 12 that houses an inner bypass body 14, wherein the inner bypass body 14 is coaxial with the shock outer body 12 thereby forming a shock body that is a twin tube with internal bypass. The shock absorber may further include a main piston 16 coupled within the inner bypass body 14 and connected to a shaft 18. The shaft 18 may extend into the shock absorber 10 and provide a means for the main piston 16 to move within the inner bypass body 14.

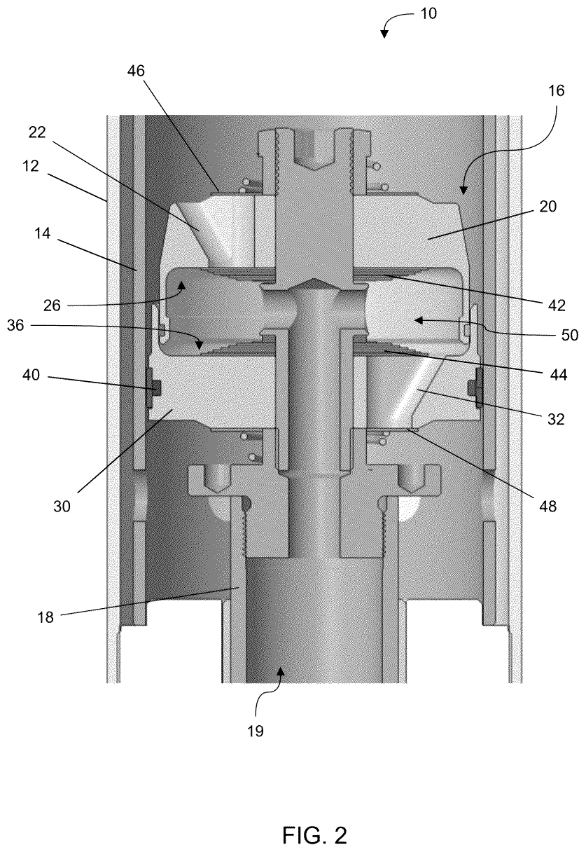

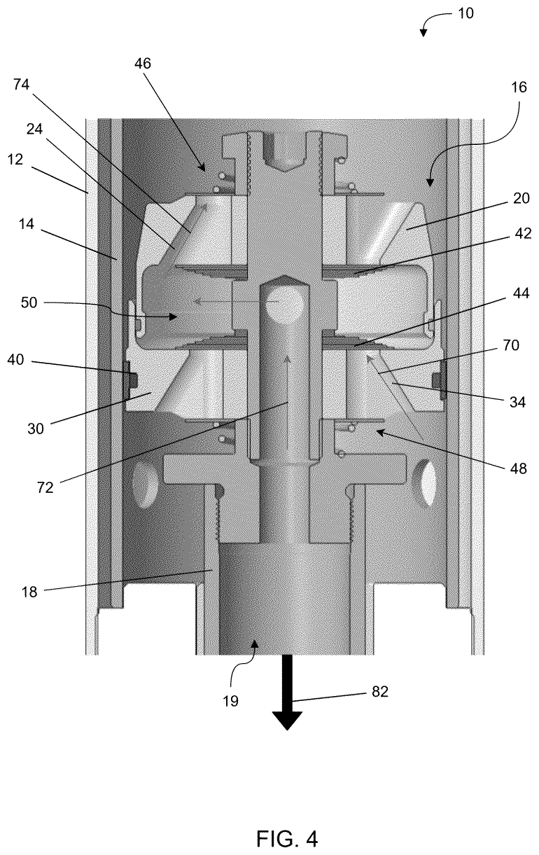

In some embodiments, as shown in FIG. 2, the main piston 16 may comprise a first piston member 20 and a second piston member 30 that are coupled together. This coupling may be any type of coupling that maintains the first piston member 20 coupled to the second piston member 30 during operation of the shock absorber 10. A wear band/o-ring 40 may be coupled around one of the first piston member 20 or the second piston member 30, providing sealing between compression and rebound sides of the main piston 16. As depicted, the wear band/o-ring 40 is coupled around the second piston member 30. In at least this way, the wear band/o-ring 40 is coupled around the main piston 16. The first piston member 20 may include a first recessed portion 26 and the second piston member 30 may include a second recessed portion 36. When the first piston member 20 is coupled to the second piston member 30, the first recessed portion 26 and the second recessed portion 36 are located to form a piston inner volume 50. The first piston member 20 may include a first compression port 22, and the second piston member 30 may include a second compression port 32 wherein the first compression port 22 and the second compression port 32 provide fluid flow access from one side of the first piston member 20 and second piston member 30, respectively, to the piston inner volume 50. The first piston member 20 may include a first rebound port 24, and the second piston member 30 may include a second rebound port 34 wherein the first rebound port 24 and the second rebound port 34 provide fluid flow access from one side of the first piston member 20 and second piston member 30, respectively, to the piston inner volume 50 (See FIG. 4).

The main piston 16 may further comprise compression valving 42 and rebound valving 44 operatively coupled within the piston inner volume between the first piston member 20 and second piston member 30. The compression valving 42 may be coupled adjacent the first piston member 20 for controlling fluid flow during a compression stroke of the shock absorber 10. The rebound valving 44 may be coupled adjacent the second piston member 30 for controlling fluid flow during a rebound stroke of the shock absorber 10. Further, the main piston 16 may comprise a first check valve 46 and a second check valve 48 to regulate fluid flow through the main piston 16. The shaft 18 may include a shaft inner volume 19 that allows hydraulic fluid to flow through the shaft inner volume 19 of the hollow shaft 18 to a reservoir to account for shaft volume displacement of hydraulic fluid during a compression stroke and then to supply the displaced hydraulic fluid through the shaft inner volume 19 of the shaft 18 back into the shock absorber 10 during a rebound stroke.

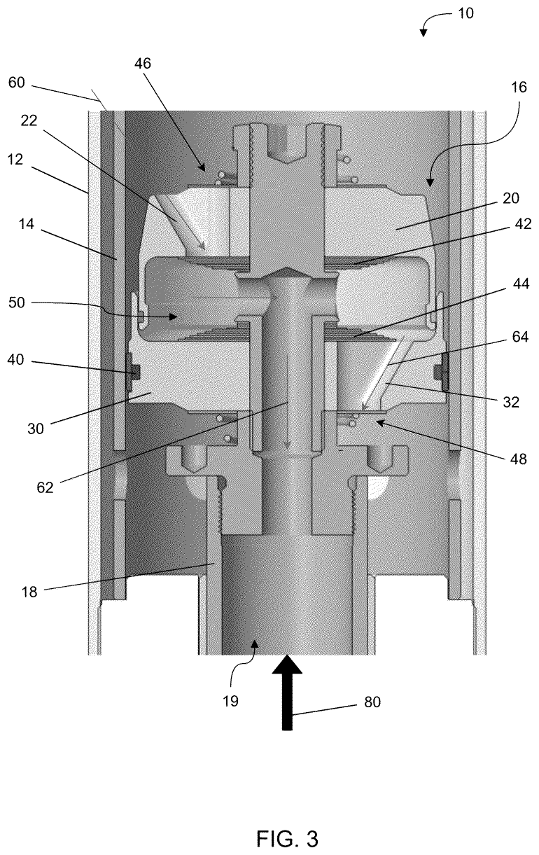

FIG. 3 depicts the shock absorber 10 during a compression stroke in a direction depicted by compression movement arrow 80. During compression, compression damping flow 60 may move through the first compression port 22 dampened by the compression valving 42. When the pressure of the fluid entering the first compression port 22 from the compression side of the main piston 16 exceeds the force of the compression valving 42, hydraulic fluid will flow into the piston inner volume 50 and be directed into shaft inner volume 19 may allow shaft volume flow to travel through the shaft 18 and to the reservoir (not shown). A portion of the hydraulic fluid is also directed through the second compression port 32 and is regulated by the second check valve 48 by only allowing fluid to flow through the second compression port 32 if the pressure exceeds the pressure of the force of the second check valve 48. In compression, the wear band/o-ring 40 is coupled to the main piston 16 and engages an inner wall of the inner bypass body 14 that prevent or inhibits fluid flow around the main piston 16 between the compression side and the rebound side of the main piston 16. In this way, the wear band/o-ring 40 operates to direct fluid flow through the main piston during compression and rebound strokes. The single wear band/o-ring 40 allows the main piston to be used various types of shock absorbers 10 including shock absorbers 10 that have an internal bypass as depicted in the drawing figures.

FIG. 4 depicts the shock absorber 10 during a rebound stroke in a direction depicted by rebound movement arrow 82. During rebound, rebound damping flow 70 may move through the second rebound port 24 dampened by the rebound valving 44. When the pressure of the fluid entering the second rebound port 24 from the rebound side of the main piston 16 exceeds the force of the rebound valving 44, hydraulic fluid will flow into the piston inner volume 50 and be joined with hydraulic fluid flowing in the piston inner volume 50 from the reservoir (not shown) through the shaft inner volume 19 of the shaft 18 to allow shaft volume flow to travel through the shaft 18 from the reservoir (not shown) and into the shock absorber to replace the shaft volume displacement of hydraulic fluid when it is decreased by the shaft 18 vacating the inner bypass body 14 during the rebound stroke. The hydraulic fluid within the piston inner volume 50 is then directed through the first rebound port 34 and is regulated by the first check valve 46 by only allowing fluid to flow through the first rebound port 34 if the pressure exceeds the pressure of the force of the first check valve 46. In rebound, the wear band/o-ring 40 is coupled to the main piston 16 and engages an inner wall of the inner bypass body 14 that prevent or inhibits fluid flow around the main piston 16 between the compression side and the rebound side of the main piston 16. In this way, the wear band/o-ring 40 operates to direct fluid flow through the main piston during compression and rebound strokes. The single wear band/o-ring 40 allows the main piston to be used various types of shock absorbers 10 including shock absorbers 10 that have an internal bypass as depicted in the drawing figures.

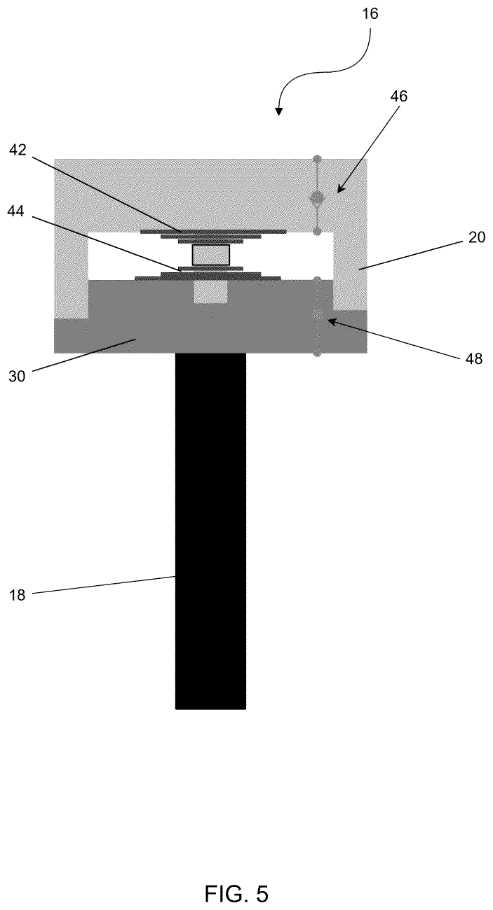

In another embodiment, as shown in FIG. 5, the first piston member 20 and second piston member 30 may be configured to clamp together, securing the compression valving 42 and rebound valving 44 between them. This arrangement may enable controlled fluid flow through the shock absorber 10 during compression and rebound movements. The shock absorber 10 may include position sensitive damping and first and second check valves 46 and 48 to operate with the compression and rebound valving 42 and 44 to regulate and control hydraulic fluid flow through the main piston 16. In other embodiments, an optional air valve may be incorporated into the shock absorber 10 design. The inner bypass body 14 may be disposed within the shock outer body 12, and the main piston 16 may be configured to move within the inner bypass body 14, providing additional damping characteristics.

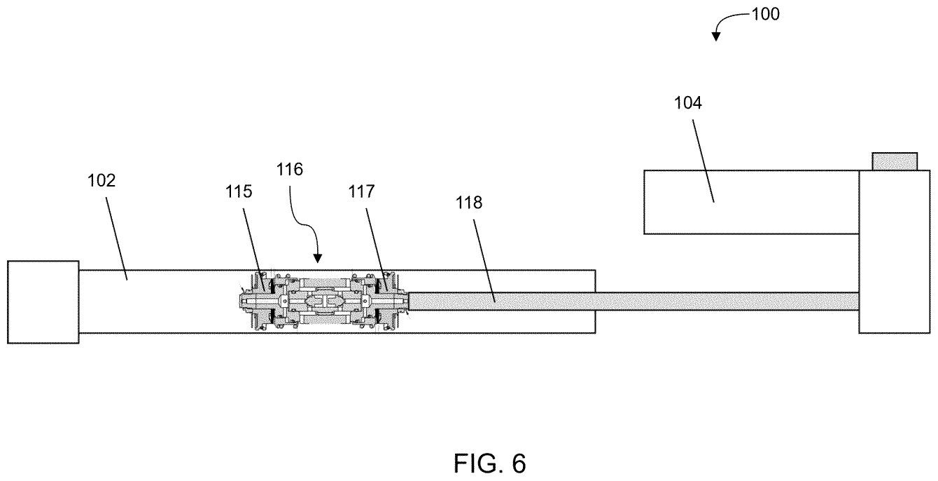

Referring to the drawings, another embodiment depicted in FIG. 6 may include a shock absorber 100. The shock absorber 100 may include a shock body 102 and a reservoir 104 coupled to the shock body 102. A twin piston device 116 may be disposed within the shock body 102. The twin piston device 116 may comprise a first piston 115 and a second piston 117 arranged in series and coaxial with a shaft 118 coupled to the twin piston device 116 to provide operational movement of the twin piston device 116 in compression and rebound strokes of the shock absorber 100. The reservoir 104 may be fluidly coupled to one end of the shock body 102, providing fluid access to the fluid reservoir 104 from the shock absorber 100.

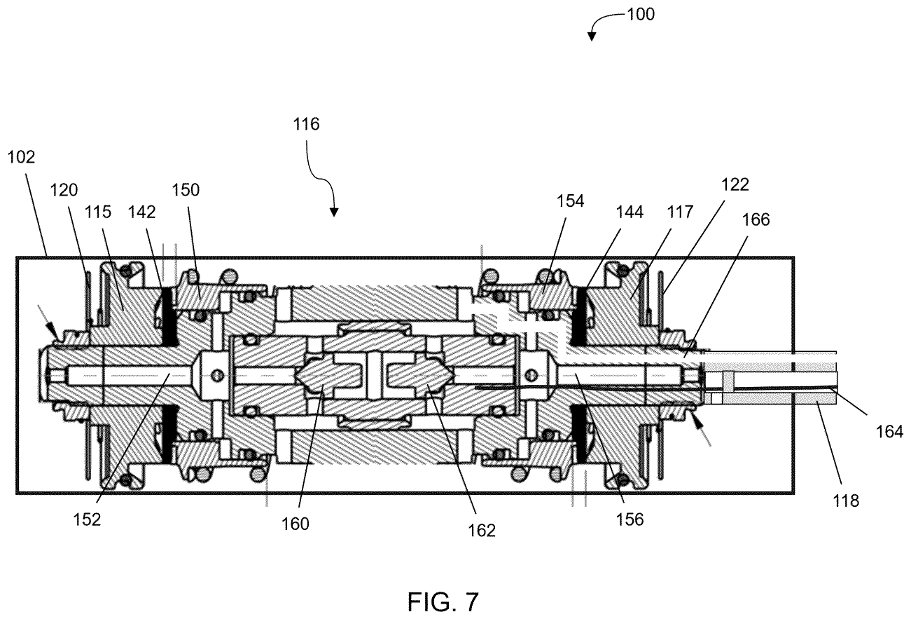

FIG. 7 depicts a sectional view of the shock absorber 100, showing additional internal components according to an embodiment. The twin piston device 116 may further include compression valving 142 and rebound valving 144 may be coupled adjacent the first piston 115 and the second piston 117 respectively. A first boost valve 150 may be coupled around a first central chamber 152 and positioned to engage the compression valving 142. Similarly, a second boost valve 154 may be coupled around a second central chamber 156 and positioned to engage the rebound valving 144. The first and second boost valves 150 and 154 provide damping support to the passive components, such as the compression valving 142 and the rebound valving 144 respectively. The first and second boost valves 150 and 154 provide increased force necessary for the compression valving 142 and the rebound valving 144, respectively, to operate to allow hydraulic fluid to flow into the twin piston device 116.

Further, the twin piston device 116 may include a first check shim 120 coupled adjacent the first piston 115 on a compression side of the twin piston device 116 and a second check shim 122 coupled adjacent the second piston 117 on a rebound side of the twin piston device 116. The first and second check shims 120 and 122 are tunable and to allow for frequency dependent damping. For example, and without limitation, some embodiments allow for tuning the first and second check shims 120 and 122 so that each are held open to allow less damping during higher frequency, thereby resulting in lower displacement events like chatter. The first and second check shims 120 and 122 may also be held close during larger displacement, lower frequency events, thereby resulting in the twin piston device 116 operating as normally designed. This twin piston device 116 allows users to apply frequency sensitive damping concepts using the first and second check shims 120 and 122.

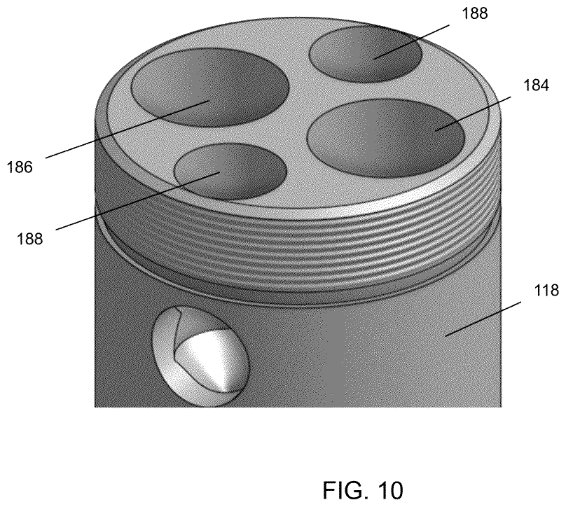

The twin piston device 116 may include a first electronic valve 160 and a second electronic valve 162, wherein the first electronic valve 160 is operatively coupled to engage an opening to the first central chamber 152 and the second electronic valve 162 is operatively coupled to engage an opening to the second central chamber 156. These electronic valves 160 and 162 may provide adjustable damping control be damping flow of hydraulic fluid through the respective central chambers 152 and 156. The shaft 118 may include a shaft displacement port 186 (See FIG. 10) that engages shaft displacement port 166 of the twin piston device 116 to enable fluid flow through the twin piston device 116 and the through the shaft 118 to the reservoir 104 to account for shaft volume displacement of the hydraulic fluid within the shock absorber 100. Wiring 164 may run through a wiring port 184 (See FIG. 10) of the shaft 118 to supply power to the first electronic valve 160 and the second electronic valve 162. Control of the power supplied may through components like an electronic control unit, an on board computer, sensors and the like. In embodiments, the first and second electronic valves 160 and 162 may be in an opened position when no power is supplied and closing when power is supplied, or may be in a closed position when no power is supplied and opening when power is supplied.

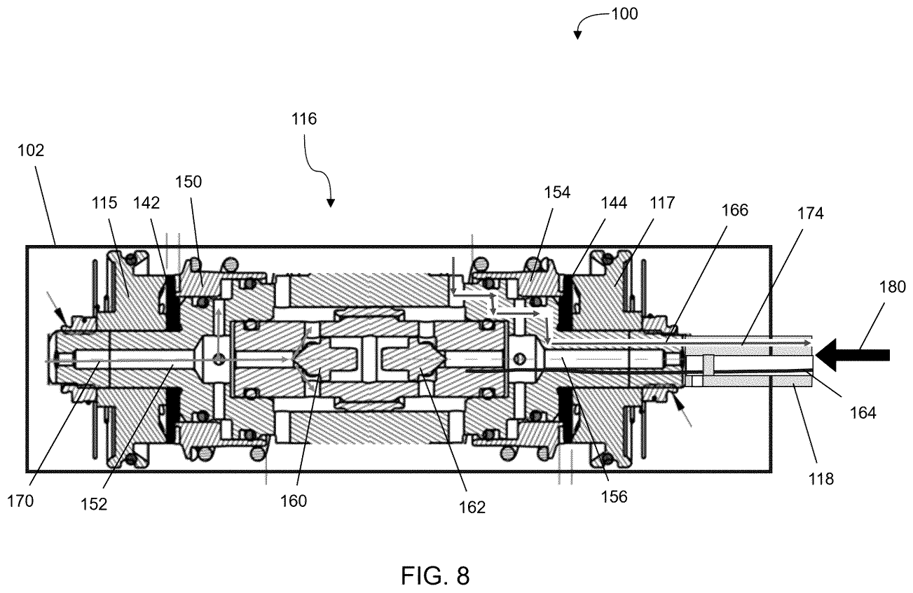

FIG. 8 depicts an embodiment of the shock absorber 100 during a compression stroke. During compression, compression flow 170 may flow through the first piston member 115 of the twin piston device 116 and directly into the first central chamber 152, while shaft displacement flow 174 may travel through the shaft displacement port 166 and then through the shaft displacement port 186 of the shaft 118 to the reservoir 104. During operation in instances where an increase in damping is needed, the first electronic valve 160 may be placed into the closed position to inhibit compression flow 174 through the first central chamber 152. Hydraulic pressure increases and provides additional force to the first boost valve 150 to prevent the compression valving 142 from opening and directing all fluid flow directly into the first central chamber 152. Once the pressure of the fluid within the first central chamber 152 overcomes the force of the closed first electronic valve 160, the first electronic valve will open allowing fluid to flow through the valve as shown in FIG. 8. In this condition the first boost valve 150 and the compression valving will operate as normal to allow fluid flow through the ports of the first piston member 115. Additionally, during operation in instance where no increase in damping is needed, the first electronic valve 160 may be opened and the twin piston device 116 operates with the first piston member 115 with the compression valving 142 and first boost valve 150 controlling the damping without the assistance of the first electronic valve 160. It will be understood that damping characteristics are affected by partially closing the first electronic valve 160 and compression damping can be tuned by the amount of power supplied to the first electronic valve 160 to adjust the opening fluid can flow through the first electronic valve 160.

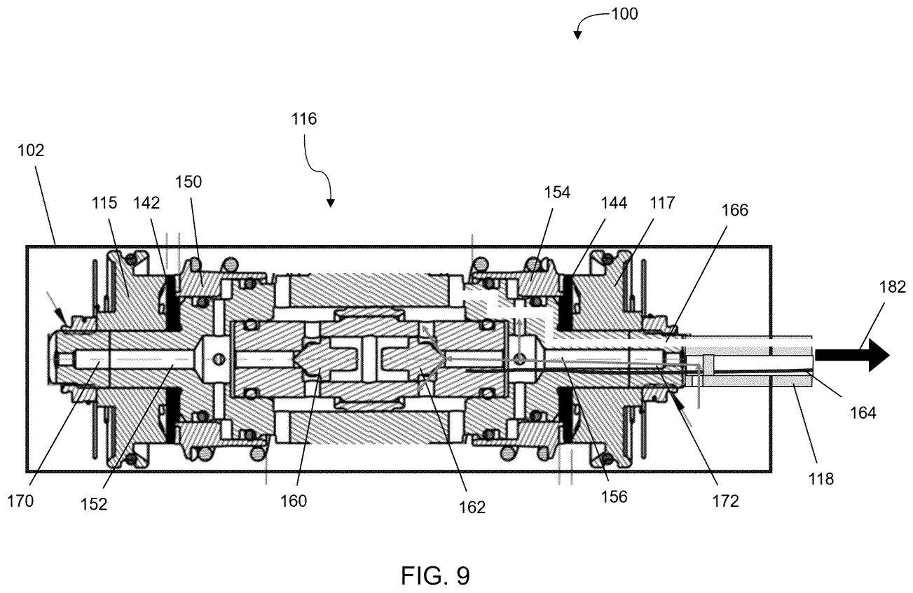

FIG. 9 depicts an embodiment of the shock absorber 100 during a rebound stroke. During rebound, rebound flow 172 may flow through the second piston member 117 of the twin piston device 116 and directly into the second central chamber 156, while shaft displacement flow 176 may travel through the shaft displacement port 166 from the the shaft displacement port 186 of the shaft 118 (as supplied from the reservoir 104) and into the shock body 102. During operation in instances where an increase in damping is needed, the second electronic valve 162 may be placed into the closed position to inhibit rebound flow 172 through the second central chamber 156. Hydraulic pressure increases and provides additional force to the second boost valve 154 to prevent the rebound valving 144 from opening and directing all fluid flow directly into the second central chamber 156. Once the pressure of the fluid within the second central chamber 156 overcomes the force of the closed second electronic valve 162, the second electronic valve 162 will open allowing fluid to flow through the valve 162 as shown in FIG. 9. In this condition the second boost valve 154 and the rebound valving 144 will operate as normal to allow fluid flow through the ports of the second piston member 117. Additionally, during operation in instance where no increase in damping is needed, the second electronic valve 162 may be opened and the twin piston device 116 operates with the second piston member 117 with the rebound valving 144 and second boost valve 154 controlling the damping without the assistance of the second electronic valve 162. It will be understood that damping characteristics are affected by partially closing the second electronic valve 162 and rebound damping can be tuned by the amount of power supplied to the second electronic valve 162 to adjust the opening fluid can flow through the second electronic valve 162.

The twin piston device 116, along with its associated valves and fluid flow paths, may work together to provide damping and maintain pressure balance within the shock absorber 100. This configuration may allow for precise control of fluid movement during both compression and rebound strokes, thereby enhancing the overall performance of the shock absorber 100.

The configuration of the twin piston device 116, with the first piston 115 and the second piston 117 arranged in series along the shaft 118, may allow for precise control of fluid movement. This arrangement may enable the shock absorber 100 to maintain optimal pressure balance and damping performance across various operating conditions.

In some embodiments, the shock absorber 100 may include additional components such as an outer sleeve, an inner sleeve, a roll control rebound valve, and a roll control compression valve. A roll control circuit may be incorporated, with the roll control compression valve coupled to the roll control circuit, and the roll control circuit coupled to the roll control rebound valve. The shock absorber 100 may also include an internal base valve. In some configurations, the base valve may be coupled to the roll control compression valve. An accumulator may be included in the shock absorber 100 design to provide additional fluid capacity or pressure regulation.

FIG. 10 depicts a perspective view of a portion of the shaft 118 according to an embodiment, showing internal ports and passages. The shaft 118 may include multiple ports arranged around its circumference to facilitate fluid flow and electrical connectivity within the shock absorber 100. In some embodiments, the shaft 118 may comprise a wiring port 184 that provides a passage for electrical connections. The wiring port 184 may be separate from the fluid flow paths within the shaft 118. This configuration may allow for the isolation of electrical components from hydraulic fluid, potentially enhancing the reliability and safety of the shock absorber 100. The shaft 118 may include a shaft displacement port 186 incorporated into its structure. The shaft displacement port 186 may be configured to enable fluid flow from the shock absorber 100 to the reservoir 104. This port may play a role in managing fluid displacement from shaft volume during compression and rebound strokes of the shock absorber 100. Further, in some embodiments, multiple compression/rebound communication ports 188 may be positioned around the circumference of the shaft 118. These compression/rebound communication ports 188 may allow for fluid communication between different sections of the shock absorber 100. The arrangement of these ports may contribute to the overall fluid flow characteristics and pressure balance within the shock absorber 100.

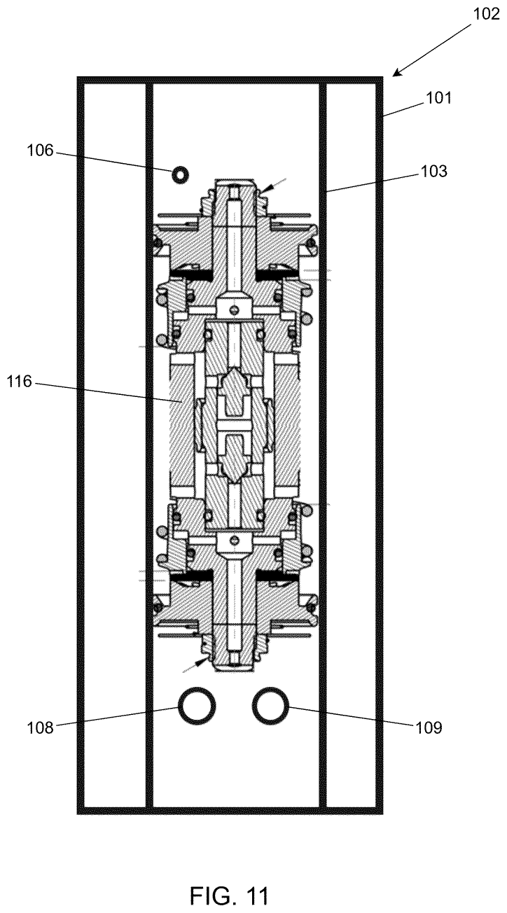

Further, referring to FIG. 11, the twin piston device 116 may be utilized in a shock absorber 100 that comprises an internal bypass having a shock body 102 that comprises an inner shock body 103 and an outer shock body 101. The inner shock body may further comprise a bleed hole 106 on a compression side of the twin piston device 116 and reflow holes 108 and 109 on the rebound side of the twin piston device 116. This embodiment with the twin piston device 116 provides unique bypass zone tunable elements such as, without limitation, a top out zone that does not affect compression, wherein compression bleed zones may be shorter in length than rebound bleed zones. According to this embodiment the two pistons 115 and 117 of the twin piston device 116 pass the zones at different shaft travel in compression and rebound.

The shock absorber may include various components that interact to provide damping performance and pressure balance. In some embodiments, the shock absorber may comprise a roll bypass valve. This roll bypass valve may allow for controlled fluid flow between different chambers of the shock absorber, potentially enhancing the overall damping characteristics.

The shock absorber may utilize a dielectric fluid to separate positive and negative nodes within the device. This configuration may allow for the integration of electronic components while maintaining electrical isolation from the hydraulic system. The use of a dielectric fluid may contribute to the reliability and safety of the shock absorber, particularly in designs incorporating electronic valves or sensors.

In some embodiments, the shock absorber may include a finned tube for rebound roll. The finned tube may provide additional surface area for heat dissipation, potentially improving the thermal management of the shock absorber during operation. This feature may be particularly beneficial in applications where the shock absorber experiences frequent or intense rebound movements.

The interaction of these components may contribute to the anti-cavitation performance of the shock absorber. For example, the roll bypass valve may help maintain proper fluid distribution within the shock absorber, reducing the likelihood of cavitation occurring during rapid compression or rebound movements. The finned tube for rebound roll may assist in managing fluid temperatures, which may also play a role in preventing cavitation.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An anti-cavitation piston for use in a shock absorber, comprising:
a main piston comprising:
a first piston member;
a second piston member coupled to the first piston member;
a single wear band coupled around the first piston member and the second piston member, wherein the single wear band separates a compression side from a rebound side of the main piston;
a first recessed portion in the first piston member;
a second recessed portion in the second piston member, wherein the first recessed portion and the second recessed portion form a piston inner volume when the first piston member is coupled to the second piston member;
a first compression port in the first piston member providing fluid flow access to the piston inner volume;
a first rebound port in the second piston member providing fluid flow access to the piston inner volume; and
compression valving and rebound valving operatively coupled within the piston inner volume between the first piston member and the second piston member.

2. The anti-cavitation piston of claim 1, wherein the main piston further comprises:
a second compression port in the second piston member providing fluid flow access to the piston inner volume; and
a second rebound port in the first piston member providing fluid flow access to the piston inner volume.

3. The anti-cavitation piston of claim 2, wherein the main piston further comprises:
a first check valve operatively coupled to regulate fluid flow through the first rebound port; and
a second check valve operatively coupled to regulate fluid flow through the second compression port.

4. The anti-cavitation piston of claim 3, wherein the first check valve and the second check valve are configured to allow fluid communication between the compression side and the rebound side of the main piston.

5. The anti-cavitation piston of claim 1, wherein the first piston member and the second piston member are configured to clamp together, securing the compression valving and rebound valving between them.

6. The anti-cavitation piston of claim 1, wherein the single wear band comprises an o-ring.

7. The anti-cavitation piston of claim 1, wherein the main piston is configured for use in a shock absorber having an internal bypass.

8. The anti-cavitation piston of claim 7, wherein the single wear band is configured to engage an inner wall of an inner bypass body of the shock absorber to direct fluid flow through the main piston during compression and rebound strokes.

9. An anti-cavitation piston for use in a shock absorber, comprising:
a twin piston device comprising:
a first piston and a second piston arranged in series and coupled to a shaft of the shock absorber;
a first central chamber adjacent to the first piston;
a second central chamber adjacent to the second piston;
a first electronic valve operatively coupled to engage an opening to the first central chamber;
a second electronic valve operatively coupled to engage an opening to the second central chamber; and
a shaft displacement port configured to enable fluid flow through the twin piston device and through the shaft.

10. The anti-cavitation piston of claim 9, further comprising:
compression valving coupled adjacent to the first piston; and
rebound valving coupled adjacent to the second piston.

11. The anti-cavitation piston of claim 10, further comprising:
a first boost valve coupled around the first central chamber and positioned to engage the compression valving; and
a second boost valve coupled around the second central chamber and positioned to engage the rebound valving.

12. The anti-cavitation piston of claim 11, wherein the first electronic valve and the second electronic valve are configured to provide adjustable damping control by damping flow of hydraulic fluid through the respective central chambers.

13. The anti-cavitation piston of claim 12, wherein the shaft comprises:
a wiring port configured to supply power to the first electronic valve and the second electronic valve; and
a shaft displacement port configured to enable fluid flow through the twin piston device and through the shaft to a reservoir.

14. The anti-cavitation piston of claim 13, wherein the shaft further comprises multiple compression/rebound communication ports positioned around a circumference of the shaft.

15. The anti-cavitation piston of claim 14, wherein the first electronic valve and the second electronic valve are configured to be in an opened position when no power is supplied and to close when power is supplied.

16. The anti-cavitation piston of claim 15, wherein the first electronic valve and the second electronic valve are configured to partially close in response to varying amounts of power supplied, allowing for tunable damping characteristics.

17. The anti-cavitation piston of claim 9, further comprising a first check shim coupled adjacent the first piston on a compression side of the twin piston device and a second check shim coupled adjacent the second piston on a rebound side of the twin piston device.

18. The anti-cavitation piston of claim 17, wherein the first and second check shims are tunable and to allow for frequency dependent damping.
